(19) United States
(12) Patent Application Publication
(10) Pub. No.: US 2026/0197821 A1
(43) Pub. Date: Jul. 9, 2026

(54) TERMINAL AND COMMUNICATION METHOD

(71) Applicant: NTT DOCOMO, INC., Tokyo (JP)

(72) Inventors: Yuki TAKAHASHI, Tokyo (JP); Satoshi NAGATA, Tokyo (JP)

(73) Assignee: NTT DOCOMO, INC., Tokyo (JP)

(21) Appl. No.: 18/726,450

(22) PCT Filed: Jan. 6, 2022
(86) PCT No.: PCT/JP2022/000220

§ 371 Date: Jul. 3, 2024

(51) Int. Cl. H04W 72/1268; H04W 72/232

(52) U.S. Cl. CPC H04W 72/1268; H04W 72/232

(57) ABSTRACT

This terminal comprises: a control unit that multiplexes channels of different priorities; and a transmission unit that transmits the multiplexed channel regardless of an instruction to cancel uplink transmission.

### TECHNICAL FIELD

The present disclosure relates to a terminal and a communication method.

### BACKGROUND ART

Long Term Evolution (LTE) has been specified for achieving a higher data rate, lower latency, and the like in a Universal Mobile Telecommunication System (UMTS) network. Future systems of LTE have also been studied for achieving a broader bandwidth and a higher speed based on LTE. Examples of the future systems of LTE include systems called LTE-Advanced (LTE-A), Future Radio Access (FRA), 5th generation mobile communication system (5G), 5G plus (5G+), Radio Access Technology (New-RAT), New Radio (NR), and the like.

3GPP has developed schemes called Ultra-Reliable and Low Latency Communications (URLLC) and Industrial Internet of Things (IIoT) in Rel. 17, and several techniques have been approved (see, for example, Non-Patent Literature (hereinafter referred to as “NPL”) 1). For example, in Rel. 17, techniques related to intra-UE multiplexing and intra-UE prioritization of traffic with different priorities have been approved (specified) based on work done in Rel. 16 (RAN1).

For example, multiplexing behavior among HARQ-ACK/SR/CSI and PUSCH for traffic with different priorities, including the cases with UCI on PUCCH and UCI on PUSCH, has been specified.

Further, PHY prioritization of overlapping dynamic grant PUSCH (DG PUSCH) and configured grant PUSCH (CG PUSCH) has been specified, taking the solution developed during Rel. 16 as the baseline. The DG PUSCH and CG PUSCH may be of different physical priorities (PHY priorities) on a BWP of a serving cell, and the serving cell may include the related cancelation behavior for the PUSCH of lower PHY priority.

Note that, RAN is an abbreviation for Radio Access Network. PUCCH is an abbreviation for Physical Uplink Control Channel. PUSCH is an abbreviation for a Physical Uplink Shared Channel. UCI is an abbreviation for Uplink Control Information. HARQ-ACK is an abbreviation for Hybrid Automatic Repeat Request-Acknowledgement. SR is an abbreviation for Scheduling Request. CSI is an abbreviation for Channel State Information. BWP is an abbreviation for Band Width Part.

### CITATION LIST

### Non-Patent Literature

### NPL 1

“Enhanced Industrial Internet of Things (IoT) and ultra-reliable and low latency communication (URLLC) support for NR”, RP-201310, 3GPP TSG RAN Meeting #88e, 3GPP, June-July 2020

### SUMMARY OF INVENTION

However, there has not been sufficient study on cancellation of uplink transmission of channels of different priorities in which intra-UE multiplexing has been performed, and further study in this respect is demanded.

One aspect of the present disclosure is to provide a terminal and a communication method of appropriately canceling uplink transmission of channels of different priorities in which intra-UE multiplexing has been performed.

### Solution to Problem

A terminal according to one aspect of the present disclosure includes: a receiver that receives a downlink control signal in a specific format for notifying a Physical Resource Block (PRB) and an Orthogonal Frequency Division Multiplexing (OFDM) symbol where the terminal cancels an uplink transmission from the terminal; and a processor that cancels, based on a indication in the downlink control signal, an uplink shared channel transmission in which uplink control information of different priorities has been multiplexed.

A communication method according to one aspect of the present disclosure includes: receiving, by a terminal, a downlink control signal in a specific format for notifying a Physical Resource Block (PRB) and an Orthogonal Frequency Division Multiplexing (OFDM) symbol where the terminal cancels an uplink transmission from the terminal; and canceling, by the terminal, based on a indication in the downlink control signal, an uplink shared channel transmission in which uplink control information of different priorities has been multiplexed.

### BRIEF DESCRIPTION OF DRAWINGS

FIG. 1 illustrates an overall schematic configuration of a radio communication system according to an embodiment;

FIG. 2 illustrates a configuration example of a radio frame, sub frames, and slots used in the radio communication system;

FIG. 3 illustrates an exemplary UL CI scheme;

FIG. 4 is a diagram provided for describing one example of Option 1 of Proposal 3;

FIG. 5 is a diagram provided for describing one example of Option 2 of Proposal 3;

FIG. 6 is a diagram provided for describing one example of Option 3 of Proposal 3;

FIG. 7 is a block diagram illustrating one example of a configuration of a base station according to the embodiment;

FIG. 8 is a block diagram illustrating one example of a configuration of a terminal according to the embodiment;

FIG. 9 illustrates an example of a hardware configuration of the base station and the terminal according to the embodiment; and

FIG. 10 illustrates one exemplary configuration of a vehicle according to the embodiment.

### DESCRIPTION OF EMBODIMENTS

Hereinafter, an embodiment according to an aspect of the present disclosure will be described in detail with reference to the accompanying drawings.

### Overall Configuration of Radio Communication System

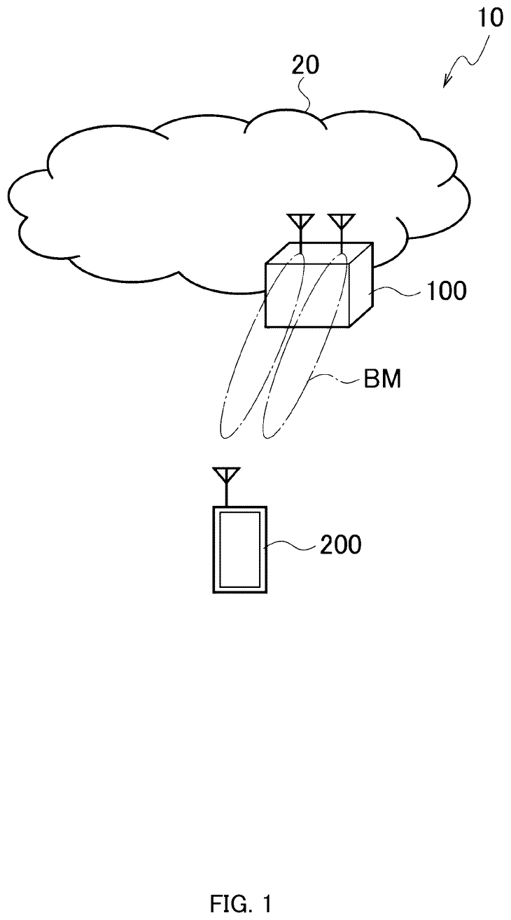

FIG. 1 illustrates an overall schematic configuration of radio communication system 10 according to an embodiment. As illustrated in FIG. 1, radio communication system 10 includes base station 100, terminal 200, and radio access network 20. Radio communication system 10 may be a radio communication system according to a scheme called 5G, Beyond 5G, 5G Evolution, or 6G.

Base station 100 may be referred to as an NG-RAN Node, an ng-eNB, an eNodeB (eNB), or a gNodeB (gNB). Terminal 200 may be referred to as User Equipment (UE). Further, base station 100 may be regarded as an apparatus included in radio access network 20 to which terminal 200 is connected.

Radio access network 20 may include a Next Generation-Radio Access Network (hereinafter referred to as NG-RAN). The NG-RAN includes a plurality of NG-RAN Nodes, specifically a plurality of gNBs (or ng-eNBs), and is connected to a core network (5GC, not illustrated) conforming to 5G. Note that, the NG-RAN and the 5GC may be simply represented as “network”.

Base station 100 executes radio communication with terminal 200. For example, the radio communication to be executed follows the NR. By controlling radio signals transmitted from a plurality of antenna elements, at least one of base station 100 and terminal 200 may support Massive Multiple-Input Multiple-Output (MIMO) that generates a beam (BM) having higher directivity. Further, at least one of base station 100 and terminal 200 may support carrier aggregation (CA) that aggregates and uses a plurality of component carriers (CC). Further, at least one of base station 100 and terminal 200 may support dual connectivity (DC) or the like that communicates between terminal 200 and each of a plurality of base stations 100.

Radio communication system 10 may support a plurality of frequency bands. For example, radio communication system 10 supports Frequency Range (FR) 1 and FR 2. The frequency bands of the respective FRs are, for example, as follows.
FR 1: 410 MHz to 7.125 GHZ
FR 2: 24.25 GHz to 52.6 GHZ

In FR 1, a Sub-Carrier Spacing (SCS) of 15 kHz, 30 kHz or 60 kHz may be used, and a bandwidth (BW) of 5 MHz to 100 MHz may be used. FR 2 is, for example, a frequency higher than FR 1. In FR 2, an SCS of 60 kHz or 120 kHz may be used and a bandwidth (BW) of 50 MHz to 400 MHz may be used. FR 2 may also include an SCS of 240 kHz.

Radio communication system 10 in the present embodiment may support a frequency band higher than the frequency band of FR 2. For example, radio communication system 10 in the present embodiment may support a frequency band exceeding 52.6 GHz and up to 114.25 GHz. Such a high frequency band may be referred to as “FR 2x”

Further, Cyclic Prefix-Orthogonal Frequency Division Multiplexing (CP-OFDM)/Discrete Fourier Transform-Spread-Orthogonal Frequency Division Multiplexing (DFT-S-OFDM) having a larger SCS than that in the example described above may be applied. Further, the DFT-S-OFDM may be applied to both the uplink and the downlink or may be applied to one thereof.

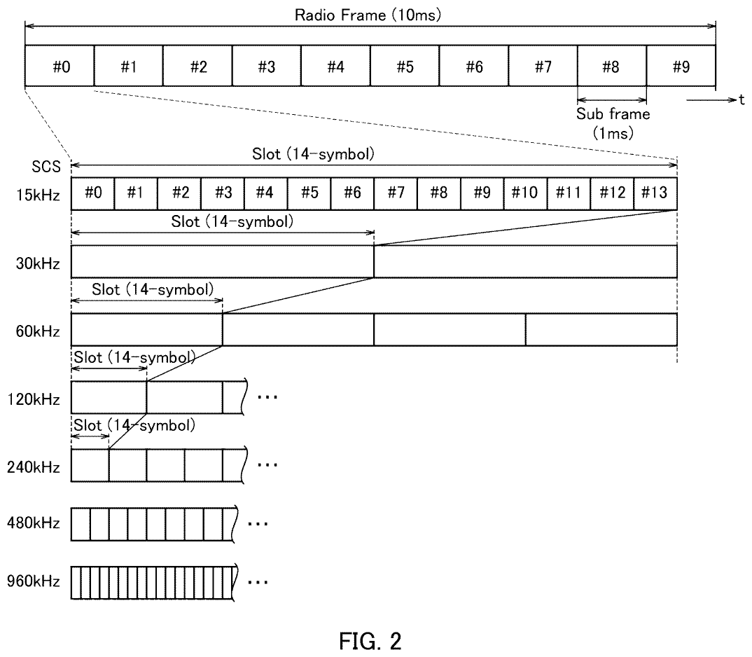

FIG. 2 illustrates a configuration example of a radio frame, sub frames, and slots used in radio communication system 10. As illustrated in FIG. 2, one slot is formed of 14 symbols, and the symbol duration (and slot duration) become(s) shorter as the SCS becomes larger (wider). Note that, the number of symbols forming one slot may not necessarily be 14 symbols. For example, the number of symbols forming one slot may be 28 or 56 symbols. In addition, the number of slots per sub frame may vary depending on the SCS. Further, the SCS may be wider than 240 kHz.

The time direction (t) illustrated in FIG. 2 may be referred to as a time domain, a symbol duration, a symbol time, or the like. Further, the frequency direction may be referred to as a frequency domain, a resource block, a subcarrier, a bandwidth part (BWP), or the like.

Radio communication system 10 may use a plurality of Downlink Control Information (DCI). The DCI may be interpreted as control information transmitted on the downlink, including scheduling information, data modulation, channel coding rate information, and the like, required for each user (UE) to demodulate data.

### Agreed Contents

In Rel. 17 of 3GPP, several techniques have been agreed on intra-UE multiplexing of traffic with different priorities.

For example, it has been agreed to support multiplexing of HARQ-ACK with different priorities, and the like, on PUCCH. Further, it has been agreed to support multiplexing of HARQ-ACK with different priorities, and the like, on PUSCH.

Note that, the traffic may be read as channel, data channel, control channel, path, data, control data, or the like. HARQ-ACK is an example of information on a confirmation response (for example, acknowledgement) to data received by the terminal.

### Instruction to Cancel UL Transmission

Rel. 16 of 3GPP introduces DCI format 2_4 for pre-empting a high-priority UL transmission and canceling a low-priority UL transmission (see, for example, TS 38.212 v16.7.0 Sec. 7.3.1.3.5 and TS 38.213 v16.7.0Sec. 11.2A).

DCI format 2_4 may be used for notifying a group of terminals of the physical resource block(s) (PRB(s)) and OFDM symbol(s) where a terminal cancels the corresponding UL transmission from the terminal. That is, DCI format 2_4 may be interpreted as a format for notifying the PRB(s) and OFDM symbol(s) where the terminal cancels UL transmission. Note that, the term: cancel may be read as annul, suspend, stop, drop, or delete, or the like.

The terminal can cancel, for example, UL transmission, such as PUSCH transmission or Sounding Reference Signal (SRS) transmission, based on UL Cancellation Indication (hereinafter may also be referred to as UL CI) indicated by DCI format 2_4. Note that, PUCCH may be canceled by UL CI.

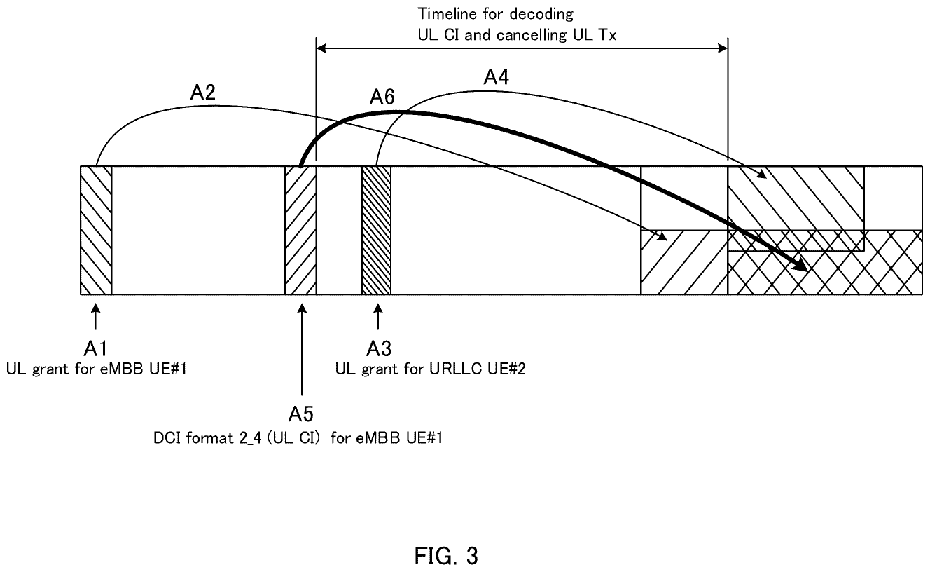

FIG. 3 illustrates an exemplary UL CI scheme. UE #1 for enhanced Mobile Broadband (eMBB) receives a UL grant, for example, in the resource indicated by arrow A1. UE #1 that has received the UL grant schedules UL transmission, for example, in the resource indicated by arrow A2.

UE #2 for URLLC receives a UL grant, for example, in the resource indicated by arrow A3. UE #2 that has received the UL grant schedules UL transmission, for example, in the resource indicated by arrow A4.

UE #1 is notified of UL CI based on DCI format 2_4, for example, in the resource indicated by arrow A5. When UE #1 is notified of the UL CI, UE #1 cancels UL transmission, for example, in the resource indicated by arrow A6 (the resource indicated by the UL CI) in the resource indicated by arrow A2 for which the UL transmission has been scheduled.

UL transmission by UE #2 for URLLC is pre-empted by the scheme described above. For example, UL transmission in the resource indicated by arrow A4 is pre-empted. That is, a high-priority UL transmission is pre-empted.

### Analysis

As described above, in Rel. 17, several techniques have been agreed on intra-UE multiplexing of traffic (channel) with different priorities.

Nonetheless, there is room for consideration on the applicability of UL CI to PUSCH including both lower-priority (LP) and high-priority (HP) channels. In other words, there is room for consideration on the applicability of UL CI to a PUSCH in which LP and HP channels have been multiplexed. For example, in a case where LP and HP channels have been multiplexed in the resource (PUSCH) indicated by arrow A2 in FIG. 3, there is room for consideration on the applicability of UL CI.

Note that, the channel may be read as signal. Further, the channel may be uplink control information such as UCI or may be uplink data such as an Uplink Shared Channel (UL-SCH). For example, both LP and HP channels may be UCI. An LP channel may be UCI and an HP channel may be UL-SCH. An LP channel may be UL-SCH and an HP channel may be UCI. Both LP and HP channels may be UCI. Further, UCI may include, for example, control information such as HARQ-ACK, SR, and CSI. Further, the PUSCH may be read as uplink channel or UL transmission.

### Proposal 1

UL CI may not be applied to a PUSCH including channels of different priorities. For example, UL CI may not be applied to a PUSCH including both LP and HP channels. In other words, the terminal may not cancel a PUSCH in which intra-UE multiplexing of LP and HP channels has been performed. Specifically, in a case where LP and HP channels are multiplexed in the resource of arrow A2 illustrated in FIG. 3, the terminal (UE #1) may not cancel UL transmission in the resource indicated by arrow A6. With this operation, a PUSCH in which HP channels have been multiplexed is transmitted without being canceled.

The terminal, on the other hand, may cancel a PUSCH including channels with only one priority, for example, based on notification of UL CI in DCI format 2_4. For example, the terminal may cancel a PUSCH including only LP channels based on notification of UL CI in DCI format 2_4. Further, the terminal may cancel a PUSCH including only HP channels based on notification of UL CI in DCI format 2_4.

Note that, the terminal may not cancel a PUSCH including both LP and HP channels, irrespective of whether there is notification of UL CI in DCI format 2_4. That is, in a case where a PUSCH includes both LP and HP channels, the terminal may not cancel the PUSCH even when the terminal is notified of UL CI. With this operation, a PUSCH in which HP channels have been multiplexed is forcibly transmitted.

Further, the base station may perform scheduling such that channels of different priorities are not included in one PUSCH (such that the terminal does not perform intra-UE multiplexing of channels of different priorities in one PUSCH). With this operation, the terminal may not assume notification from the base station with respect to cancellation of a PUSCH (UL CI) including both LP and HP channels.

### Proposal 2

UL CI may be applied to a PUSCH including channels of different priorities. For example, UL CI may be applied to a PUSCH including both LP and HP channels. In other words, the terminal may cancel a PUSCH in which intra-UE multiplexing of LP and HP channels has been performed. Specifically, the terminal (UE #1) may cancel UL transmission in the resource indicated by arrow A6 in a case where LP and HP channels are multiplexed in the resource of arrow A2 illustrated in FIG. 3.

For example, the terminal may cancel a PUSCH including both LP and HP channels based on notification of UL CI in DCI format 2_4. That is, the terminal may cancel a PUSCH including both LP and HP channels based on an instruction from the base station. With this operation, transmission of a PUSCH in which LP channels have been multiplexed is canceled. In addition, since transmission of a PUSCH in which LP channels have been multiplexed is canceled, a channel for another terminal, which is overlapping with the PUSCH (for example, a signal in the URLLC resource indicated by arrow A4 in FIG. 3), is appropriately received by the base station.

Further, the terminal may cancel a PUSCH including channels with only one priority, for example, based on notification of UL CI in DCI format 2_4. For example, the terminal may cancel a PUSCH including only LP channels based on notification of UL CI in DCI format 2_4. Further, the terminal may cancel a PUSCH including only HP channels based on notification of UL CI in DCI format 2_4.

Note that, the terminal may cancel a PUSCH including both LP and HP channels, irrespective of whether there is notification of UL CI in DCI format 2_4. That is, in a case where a PUSCH includes both LP and HP channels, the terminal may cancel the PUSCH even when the terminal is not notified of UL CI. With this operation, transmission of a PUSCH in which LP channels have been multiplexed is canceled.

### Proposal 3

The terminal may determine the application of UL CI based on a parameter(s) of higher layer signaling such as Radio Resource Control (RRC) signaling. In other words, the terminal may determine (switch) a cancellation operation of UL transmission based on a parameter(s) of higher layer signaling. With this operation, the cancellation operation of UL transmission by the terminal can be flexibly changed.

Proposal 3 may include the following three options.

### Option 1

The terminal may determine the application of UL CI to UL transmission based on an existing parameter(s). The existing parameter(s) may be, for example, an existing RRC parameter(s). The existing RRC parameter(s) may be, for example, uplinkCancellationPriority-r16 of CI-ConfigurationPerServingCell (see, for example, TS38.331 v16.7.0 Sec. 6.3.2 UplinkCancellation information element).

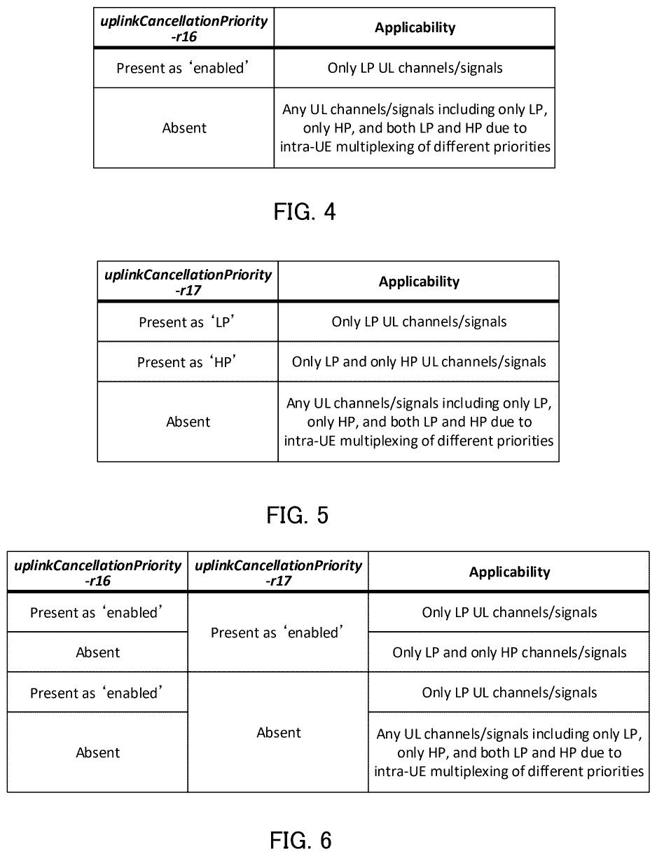

FIG. 4 is a diagram provided for describing one example of Option 1 of Proposal 3. As illustrated in FIG. 4, the application of UL CI may be determined based on the field content of uplinkCancellationPriority-r16.

For example, in a case where information indicating “enabled” is present in the field of uplinkCancellationPriority-r16 as illustrated in FIG. 4, UL CI may be applied only to UL transmission indicated (configured) as a low priority level. In other words, the terminal may cancel UL transmission including only LP channels in a case where the field of the parameter uplinkCancellationPriority-r16 received by the terminal includes information indicating “enabled” and the terminal has received UL CI.

In a case where the field of uplinkCancellationPriority-r16 is “absent” (for example, in a case where no information is present in the field) as illustrated in FIG. 4, on the other hand, UL CI may be applied to UL transmission irrespective of the priority levels of channels included in a PUSCH. In other words, the terminal may cancel UL transmission no matter what priority the channels have in a case where the field of the parameter uplinkCancellationPriority-r16 received by the terminal is “absent” and the terminal has received UL CI. For example, the terminal cancels UL transmission including only LP channels. The terminal cancels UL transmission including only HP channels. The terminal cancels UL transmission including both LP and HP channels.

### Option 2

The terminal may determine the application of UL CI to UL transmission based on a new parameter(s). The new parameter(s) may be, for example, a new RRC parameter(s). The new RRC parameter(s) may be, for example, uplinkCancellationPriority-r17 of CI-ConfigurationPerServingCell.

FIG. 5 is a diagram provided for describing one example of Option 2 of Proposal 3. As illustrated in FIG. 5, the application of UL CI may be determined based on the field content of uplinkCancellationPriority-r17.

For example, in a case where information indicating “LP” is present in the field of uplinkCancellationPriority-r17 as illustrated in FIG. 5, UL CI may be applied only to UL transmission indicated (configured) as a low priority level. In other words, the terminal may cancel UL transmission including only LP channels in a case where the field of the parameter uplinkCancellationPriority-r17 received by the terminal includes information indicating “LP” and the terminal has received UL CI.

For example, in a case where information indicating “HP” is present in the field of uplinkCancellationPriority-r17 as illustrated in FIG. 5, UL CI may be applied only to UL transmission indicated as a level equal to or lower than a high priority level. In other words, the terminal may cancel UL transmission including a channel(s) equal to or lower than an HP channel(s) in a case where the field of the parameter uplinkCancellationPriority-r17 received by the terminal includes information indicating “HP” and the terminal has received UL CI. That is, the terminal may cancel UL transmission including only LP channels and may also cancel UL transmission including only HP channels.

For example, in a case where the field of uplinkCancellationPriority-r17 is “absent” as illustrated in FIG. 5, UL CI may be applied to UL transmission irrespective of the priority levels of channels included in a PUSCH. In other words, the terminal may cancel UL transmission no matter what priority the channels have in a case where the field of the parameter uplinkCancellationPriority-r17 received by the terminal is “absent” and the terminal has received UL CI. For example, the terminal cancels UL transmission including only LP channels. The terminal cancels UL transmission including only HP channels. The terminal cancels UL transmission including both LP and HP channels.

### Option 3

The terminal may determine the application of UL CI to UL transmission based on an existing parameter(s) and a new parameter(s). The existing parameter(s) may be, for example, uplinkCancellationPriority-r16 of CI-ConfigurationPerServingCell, and the new parameter(s) may be, for example, uplinkCancellationPriority-r17 of CI-ConfigurationPerServingCell.

FIG. 6 is a diagram provided for describing one example of Option 3 of Proposal 3. As illustrated in FIG. 6, the application of UL CI may be determined based on a combination of the field (first field) content of uplinkCancellationPriority-r16 and the field (second field) content of uplinkCancellationPriority-r17.

For example, in a case where information indicating “enabled” is present in the first and second fields as illustrated in FIG. 6, UL CI may be applied only to UL transmission indicated as a low priority level. In other words, the terminal may cancel UL transmission including only LP channels in a case where the field of the parameter uplinkCancellationPriority-r16 received by the terminal includes information indicating “enabled”, the field of the parameter uplinkCancellationPriority-r17 received by the terminal includes information indicating “enabled”, and the terminal has received UL CI.

For example, in a case where the first field is “absent” and information indicating “enabled” is present in the second field as illustrated in FIG. 6, UL CI may be applied only to UL transmission indicated as a level equal to or lower than a high priority level. In other words, the terminal may cancel UL transmission including a channel(s) equal to or lower than an HP channel(s) in a case where the field of the parameter uplinkCancellationPriority-r16 received by the terminal is “absent”, the field of the parameter uplinkCancellationPriority-r17 received by the terminal includes information indicating “enabled”, and the terminal has received UL CI. That is, the terminal may cancel UL transmission including only LP channels and may also cancel UL transmission including only HP channels.

For example, in a case where information indicating “enabled” is present in the first field and the second field is “absent” as illustrated in FIG. 6, UL CI may be applied only to UL transmission indicated as a low priority level. In other words, the terminal may cancel UL transmission including only LP channels in a case where the field of the parameter uplinkCancellationPriority-r16 received by the terminal includes information indicating “enabled”, the field of the parameter uplinkCancellationPriority-r17 received by the terminal is “absent”, and the terminal has received UL CI.

For example, in a case where the first and second fields are “absent” as illustrated in FIG. 6, UL CI may be applied to UL transmission irrespective of the priority levels of channels included in a PUSCH. In other words, the terminal may cancel UL transmission no matter what priority the channels have in a case where the field of the parameter uplinkCancellationPriority-r16 received by the terminal is “absent”, the field of the parameter uplinkCancellationPriority-r17 received by the terminal is “absent”, and the terminal has received UL CI. For example, the terminal cancels UL transmission including only LP channels. The terminal cancels UL transmission including only HP channels. The terminal cancels UL transmission including both LP and HP channels.

### UE Capability

The terminal may transmit the UE capability representing the capability of the terminal to a network such as NG-RAN20, for example. The terminal may transmit the UE capability in response to reception of an enquiry about the capability of the terminal (UE Capability Enquiry) from the network.

The UE capability representing the capability of the terminal may include the following information indicating the capability of the terminal. Note that, the information indicating the capability of the terminal may correspond to information defining the capability of the terminal.
Information defining based on intra-UE multiplexing whether the terminal supports UL CI applicable to a UL channel in which LP and HP channels have been multiplexed.

The above information may include information on which proposals and which options are applied. For example, the above information may include information indicating that Proposal 2 or 3 is applied.

Further, in a case where the terminal may apply Proposal 1 in a case where the terminal does not transmit the UE capability described above. For example, the terminal may not assume notification from the base station with respect to cancellation of a PUSCH (UL CI) including both LP and HP channels.

### Variation

Although it has been described in Proposal 3 that the terminal may determine a cancellation operation of UL transmission based on a parameter(s) of higher layer signaling such as RRC signaling, the present disclosure is not limited thereto. For example, the terminal may determine a cancellation operation of UL transmission based on system information such as a Master Information Block (MIB) or a System Information Block (SIB), or lower layer signaling such as DCI. That is, the terminal may determine a cancellation operation of UL transmission based on notification of information from a network such as NG-RAN20.

The terminal may determine based on notification of informational whether to operate in either Proposal 1 or 2. That is, the terminal may perform determination based on notification of informational as to whether to apply a cancellation operation of UL transmission including channels of different priorities (channels in which intra-UE multiplexing has been performed). Note that, the term: apply may be read as enable.

The priorities of channels are not limited to two priorities as in LP and HP channels. In Proposals 1 to 3, the priorities of channels may be three or more priorities.

### Configuration of Base Station

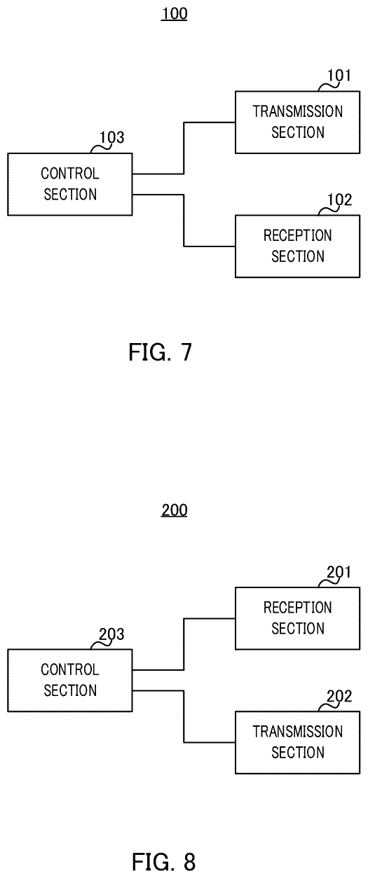

FIG. 7 is a block diagram illustrating one example of a configuration of base station 100 according to the embodiment. Base station 100 includes, for example, transmission section 101, reception section 102, and control section 103. Base station 100 performs radio communication with terminal 200 (see FIG. 8).

Transmission section 101 transmits a downlink (DL) signal to terminal 200. For example, transmission section 101 transmits the DL signal under the control of control section 103.

The DL signal may include, for example, a downlink data signal and control information (for example, Downlink Control Information (DCI)). Further, the DL signal may include information indicating scheduling related to signal transmission of terminal 200 (for example, UL grant). Further, the DL signal may include higher layer control information (for example, RRC control information). Further, the DL signal may include a reference signal.

Channels used for DL signal transmission include, for example, a data channel and a control channel. For example, the data channel may include a Physical Downlink Shared Channel (PDSCH), and the control channel may include a Physical Downlink Control Channel (PDCCH). For example, base station 100 transmits control information to terminal 200 by using PDCCH, and transmits a downlink data signal by using PDSCH.

The reference signal included in the DL signal may include, for example, at least one of a Demodulation Reference Signal (DMRS), a Phase Tracking Reference Signal (PTRS), a Channel State Information-Reference Signal (CSI-RS), a Sounding Reference Signal (SRS), and a Positioning Reference Signal (PRS) for position information. For example, the reference signal such as the DMRS and the PTRS is used for demodulation of a downlink data signal and is transmitted by using PDSCH.

Reception section 102 receives an uplink (UL) signal transmitted from terminal 200. For example, reception section 102 receives the UL signal under the control of control section 103.

Control section 103 controls communication operations of base station 100 including transmission processing in transmission section 101 and reception processing in reception section 102.

For example, control section 103 acquires information such as data and control information from a higher layer and outputs the data and the control information to transmission section 101. Further, control section 103 outputs the data, the control information, and the like received from reception section 102 to the higher layer.

For example, control section 103 allocates resources (or channels) used for transmission and reception of the DL signal and/or resources used for transmission and reception of the UL signal based on a signal (for example, data, control information, and the like) received from terminal 200 and/or data, control information, and the like obtained from the higher layer. Information on the allocated resources may be included in the control information to be transmitted to terminal 200.

As an example of the allocation of resources used for transmission and reception of the UL signal, control section 103 configures a PUCCH resource. Terminal 200 may be notified of information on the configuration of the PUCCH (PUCCH configuration information), such as a PUCCH cell timing pattern, by the RRC.

For the terminal that has not transmitted the UE capability described above, control section 103 may perform scheduling such that channels of different priorities are not included in one PUSCH (such that the terminal does not perform intra-UE multiplexing of channels of different priorities in one PUSCH). For the terminal that has transmitted the UE capability described above, control section 103 may perform scheduling such that channels of different priorities are included in one PUSCH.

### Configuration of Terminal

FIG. 8 is a block diagram illustrating one example of a configuration of terminal 200 according to the embodiment. Terminal 200 includes, for example, reception section 201, transmission section 202, and control section 203. For example, terminal 200 performs radio communication with base station 100.

Reception section 201 receives the DL signal transmitted by base station 100. For example, reception section 201 receives the DL signal under the control of control section 203.

Transmission section 202 transmits a UL signal to base station 100. For example, transmission section 202 transmits the UL signal under the control of control section 203.

The UL signal may include, for example, an uplink data signal and control information (for example, UCI). For example, the UL signal may include information on the processing capability of terminal 200 (for example, UE capability). Further, the UL signal may include a reference signal.

Channels used for UL signal transmission include, for example, a data channel and a control channel. For example, the data channel includes a Physical Uplink Shared Channel (PUSCH) and the control channel includes a Physical Uplink Control Channel (PUCCH). For example, terminal 200 receives control information from base station 100 by using PUCCH and transmits an uplink data signal by using PUSCH.

The reference signal included in the UL signal may include, for example, at least one of a DMRS, a PTRS, a CSI-RS, an SRS, and a PRS. For example, the reference signal such as the DMRS and the PTRS is used for demodulation of an uplink data signal and is transmitted by using an uplink channel (for example, PUSCH).

Control section 203 controls communication operations of terminal 200 including reception processing in reception section 201 and transmission processing in transmission section 202.

For example, control section 203 acquires information such as data and control information from a higher layer and outputs the data and the control information to transmission section 202. Further, control section 203 outputs, for example, the data, the control information, and the like received from reception section 201 to the higher layer.

For example, control section 203 controls transmission of information to be fed back to base station 100. The information to be fed back to base station 100 may include, for example, a HARQ-ACK, Channel State Information (CSI), and a Scheduling Request (SR). The information fed back to base station 100 may be included in the UCI. The UCI is transmitted in a PUCCH resource.

Control section 203 configures the PUCCH resource based on configuration information (for example, the configuration information such as the PUCCH cell timing pattern notified by RRC and/or the DCI) received from base station 100. Control section 203 determines the PUCCH resource to be used for transmission of the information to be fed back to base station 100. Transmission section 202 transmits the information to be fed back to base station 100 in the PUCCH resource determined by control section 203 under the control of control section 203.

Note that, the channels used for DL signal transmission and the channels used for UL signal transmission are not limited to the examples mentioned above. For example, the channels used for the DL signal transmission and the channels used for the UL signal transmission may include a Random Access Channel (RACH) and a Physical Broadcast Channel (PBCH). The RACH may be used for, for example, transmission of Downlink Control Information (DCI) including a Random Access Radio Network Temporary Identifier (RA-RNTI).

Here, control section 203 may multiplex channels of different priorities. For example, control section 203 may multiplex LP and HP channels.

Transmission section 202 may transmit multiplexed channels regardless of an instruction to cancel uplink transmission. In other words, transmission section 202 may not cancel multiplexed channels regardless of an instruction to cancel uplink transmission. For example, transmission section 202 may not cancel a PUSCH including LP and HP channels regardless of UL CI in DCI format 2_4. With this operation, terminal 200 can appropriately cancel uplink transmission of channels of different priorities in which intra-UE multiplexing has been performed. Further, terminal 200 can transmit multiplexed channels including HP channels.

Further, transmission section 202 may cancel transmission of channels of one priority based on an instruction to cancel uplink transmission. For example, transmission section 202 may cancel a PUSCH including only LP channels based on UL CI in DCI format 2_4. Transmission section 202 may cancel a PUSCH including only HP channels based on UL CI in DCI format 2_4. With this operation, terminal 200 can appropriately cancel transmissions of channels of one priority.

Further, transmission section 202 may cancel transmission of multiplexed channels based on an instruction to cancel uplink transmission. For example, transmission section 202 may cancel a PUSCH including LP and HP channels based on UL CI in DCI format 2_4. With this operation, terminal 200 can appropriately cancel uplink transmission of channels of different priorities in which intra-UE multiplexing has been performed. Further, terminal 200 can cancel transmission of multiplexed channels including LP channels.

Further, transmission section 202 may apply an instruction to cancel uplink transmission to multiplexed channels based on a signaling parameter. For example, transmission section 202 may apply UL CI in DCI format 2_4 to multiplexed channels based on an RRC parameter. With this operation, terminal 200 can appropriately cancel uplink transmission of channels of different priorities in which intra-UE multiplexing has been performed.

The present disclosure has been described above. Note that, the classification of items in the above description is not essential to the present disclosure, and matters described in two or more items may be used in combination as needed, or a matter described in one item may be applied (unless inconsistent) to a matter described in another item.

### Hardware Configuration and the Like

The block diagrams used to describe the above embodiment illustrate blocks in functional units. These functional blocks (component sections) are implemented by any combination of at least one of hardware and software. Further, the implementation method of each functional block is not particularly limited. That is, each functional block may be implemented by using one apparatus that is physically or logically coupled, or may be implemented by directly or indirectly (for example, by means of wire, radio, or the like) connecting two or more apparatuses that are physically or logically separated, and by using a plurality of these apparatuses. The functional blocks may be implemented by combining software with the one apparatus or the plurality of apparatuses described above.

The functions include, but not limited to, judging, deciding, determining, computing, calculating, processing, deriving, investigating, searching, confirming, receiving, transmitting, outputting, accessing, solving, selecting, choosing, establishing, comparing, assuming, expecting, regarding, broadcasting, notifying, communicating, forwarding, configuring, reconfiguring, allocating, mapping, assigning, and the like. For example, a functional block (component section) that functions to achieve transmission is referred to as “transmitting unit”, “transmission section”, or “transmitter”. In either case, the implementation method is not particularly limited as described above.

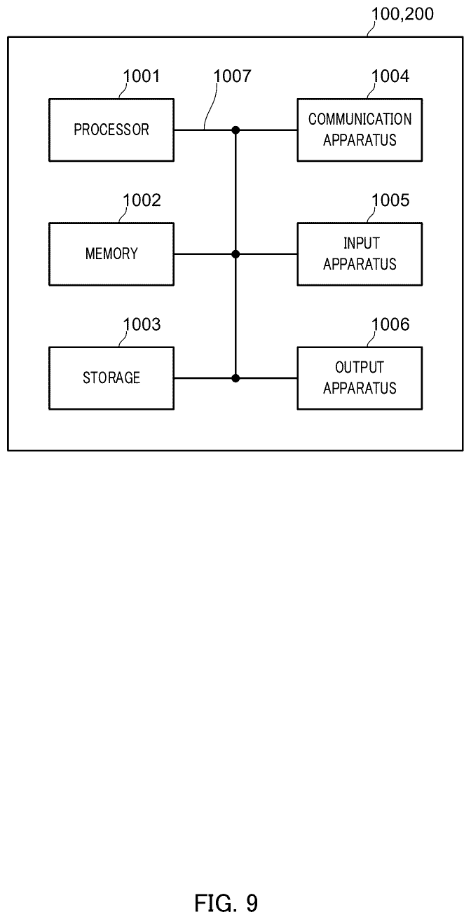

For example, base station 100, terminal 200, and the like according to an embodiment of the present disclosure may function as a computer that performs processing of the radio communication method of the present disclosure. FIG. 9 illustrates an example of a hardware configuration of base station 100 and terminal 200 according to the embodiment. Base station 100 and terminal 200 described above may be physically configured as a computer apparatus including processor 1001, memory 1002, storage 1003, communication apparatus 1004, input apparatus 1005, output apparatus 1006, bus 1007, and the like.

Note that, the term “apparatus” in the following description can be replaced with a circuit, a device, a unit, or the like. The hardware configuration of base station 100 and terminal 200 may be configured to include one or a plurality of the apparatuses illustrated in the drawing, or may be configured without one or some of the apparatuses.

Each function of base station 100 and terminal 200 is implemented by loading predetermined software (program) into hardware such as processor 1001, memory 1002, and the like, according to which processor 1001 performs the arithmetic and controls communication performed by communication apparatus 1004 or at least one of reading and writing of data in memory 1002 and storage 1003.

Processor 1001 operates an operating system to entirely control the computer, for example. Processor 1001 may be formed of a Central Processing Unit (CPU) including an interface with peripheral apparatuses, control apparatus, arithmetic apparatus, register, and the like. For example, control section 103 and control section 203 as described above may be implemented by processor 1001.

Further, processor 1001 reads a program (program code), a software module, data, and the like from at least one of storage 1003 and communication apparatus 1004 to memory 1002 and performs various types of processing according to the program (program code), the software module, the data, and the like. As the program, a program for causing the computer to execute at least a part of the operations described in the above embodiment is used. For example, control section 203 of terminal 200 may be implemented by a control program stored in memory 1002 and operated by processor 1001, and the other functional blocks may also be implemented in the same way. While it has been described that the various types of processing as described above are performed by one processor 1001, the various types of processing may be performed by two or more processors 1001 at the same time or in succession. Processor 1001 may be implemented by one or more chips. Note that, the program may be transmitted from a network via a telecommunication line.

Memory 1002 is a computer-readable recording medium and may be formed of, for example, at least one of a Read Only Memory (ROM), an Erasable Programmable ROM (EPROM), an Electrically Erasable Programmable ROM (EEPROM), and a Random Access Memory (RAM). Memory 1002 may be referred to as a register, a cache, a main memory (main storage apparatus), or the like. Memory 1002 can store a program (program code), a software module, and the like that can be executed to carry out the radio communication method according to an embodiment of the present disclosure.

Storage 1003 is a computer-readable recording medium and may be formed of, for example, at least one of an optical disk such as a Compact Disc ROM (CD-ROM), a hard disk drive, a flexible disk, a magneto-optical disk (for example, a compact disc, a digital versatile disc, or a Blu-ray (registered trademark) disc), a smart card, a flash memory (for example, a card, a stick, or a key drive), a floppy (registered trademark) disk, and a magnetic strip. Storage 1003 may also be referred to as an auxiliary storage apparatus. The storage medium as described above may be, for example, a database, a server or other appropriate media including at least one of memory 1002 and storage 1003.

Communication apparatus 1004 is hardware (transmission and reception device) for communication between computers via at least one of wired and radio networks and is also referred to as, for example, a network device, a network controller, a network card, or a communication module. Communication apparatus 1004 may be configured to include a high frequency switch, a duplexer, a filter, a frequency synthesizer, and the like in order to implement at least one of Frequency Division Duplex (FDD) and Time Division Duplex (TDD), for example. For example, transmission section 101, reception section 102, reception section 201, transmission section 202, and the like as described above may be implemented by communication apparatus 1004.

Input apparatus 1005 is an input device (for example, a keyboard, a mouse, a microphone, a switch, a button, or a sensor) that receives an input from outside. Output apparatus 1006 is an output device (for example, a display, a speaker, or an LED lamp) that performs an output to outside. Note that, input apparatus 1005 and output apparatus 1006 may be configured to be integrated (for example, a touch screen).

Further, the apparatuses, such as processor 1001, memory 1002 and the like, are connected by bus 1007 for communication of information. Bus 1007 may be configured using a single bus or using buses different between each pair of the apparatuses.

Further, base station 100 and terminal 200 may include hardware, such as a microprocessor, a Digital Signal Processor (DSP), an Application Specific Integrated Circuit (ASIC), a Programmable Logic Device (PLD), and a Field Programmable Gate Array (FPGA), and the hardware may implement one, some or all of the functional blocks. For example, processor 1001 may be implemented using at least one of these pieces of hardware.

### Notification and Signaling of Information

The notification of information is not limited to the embodiment described in the present disclosure, and the information may be notified by another method. For example, the notification of information may be carried out by one or a combination of physical layer signaling (for example, Downlink Control Information (DCI) and Uplink Control Information (UCI)), higher layer signaling (for example, Radio Resource Control (RRC) signaling, Medium Access Control (MAC) signaling, broadcast information (Master Information Block (MIB), and System Information Block (SIB)), and other signals. The RRC signaling may be called an RRC message and may be, for example, an RRC Connection Setup message, an RRC Connection Reconfiguration message, or the like.

### Applied System

The embodiment described in the present disclosure may be applied to at least one of a system using Long Term Evolution (LTE), LTE-Advanced (LTE-A), SUPER 3G, IMT-Advanced, 4th generation mobile communication system (4G), 5th generation mobile communication system (5G), 6th generation mobile communication system (6G), x-th generation mobile communication system (xG) (“x” is an integer or an decimal, for example), Future Radio Access (FRA), new Radio (NR), New Radio access (NX), Future generation radio access (FX), W-CDMA (registered trademark), GSM (registered trademark), CDMA2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), or other appropriate systems and a next-generation system extended, modified, created, or defined based on the above systems. Additionally or alternatively, a combination of two or more of the systems (for example, a combination of at least LTE or LTE-A and 5G) may be applied.

### Processing Procedure and the Like

The orders of the processing procedures, the sequences, the flowcharts, and the like of the aspects and embodiment described in the present disclosure may be changed as long as there is no contradiction. For example, elements of various steps are presented in exemplary orders in the methods described in the present disclosure, and the methods are not limited to the presented specific orders.

### Operation of Base Station

Specific operations which are described in the present disclosure as being performed by the base station may sometimes be performed by an upper node depending on the situation. Various operations performed for communication with a terminal in a network formed of one network node or a plurality of network nodes including a base station can be obviously performed by at least one of the base station and a network node other than the base station (examples include, but not limited to, MME or S-GW). Although there is one network node in addition to the base station in the case illustrated above, a plurality of other network nodes may be combined (for example, MME and S-GW).

### Direction of Input and Output

The information or the like (see the item of “Information and Signals”) can be outputted from a higher layer (or a lower layer) to a lower layer (or a higher layer). The information or the like may be inputted and outputted via a plurality of network nodes.

### Handling of Inputted and Outputted Information and the like

The inputted and outputted information and the like may be stored in a specific place (for example, memory) or may be managed using a management table. The inputted and outputted information and the like can be overwritten, updated, or additionally written. The outputted information and the like may be deleted. The inputted information and the like may be transmitted to another apparatus.

### Determination Method

The determination may be made based on a value expressed by one bit (0 or 1), based on a Boolean value (true or false), or based on comparison with a numerical value (for example, comparison with a predetermined value).

### Variations and the Like of Aspects

The aspects and embodiment described in the present disclosure may be independently used, may be used in combination, or may be switched and used along the execution. Further, notification of predetermined information (for example, notification indicating “it is X”) is not limited to explicit notification, and may be performed implicitly (for example, by not notifying the predetermined information).

While the present disclosure has been described in detail, it is obvious to those skilled in the art that the present disclosure is not limited to the embodiment described in the present disclosure. Modifications and variations of the aspects of the present disclosure can be made without departing from the spirit and the scope of the present disclosure defined by the description of the appended claims. Therefore, the description of the present disclosure is intended for exemplary description and does not limit the present disclosure in any sense.

### Software

Regardless of whether the software is called as software, firmware, middleware, a microcode, or a hardware description language or by another name, the software should be broadly interpreted to mean an instruction, an instruction set, a code, a code segment, a program code, a program, a subprogram, a software module, an application, a software application, a software package, a routine, a subroutine, an object, an executable file, an execution thread, a procedure, a function, and the like.

The software, the instruction, the information, and the like may be transmitted and received through a transmission medium. For example, when the software is transmitted from a website, a server, or another remote source by using at least one of a wired technique (for example, a coaxial cable, an optical fiber cable, a twisted pair, and a Digital Subscriber Line (DSL)) and a radio technique (for example, an infrared ray and a microwave), the at least one of the wired technique and the radio technique is included in the definition of the transmission medium.

### Information and Signals

The information, the signals, and the like described in the present disclosure may be expressed by using any of various different techniques. For example, data, instructions, commands, information, signals, bits, symbols, chips, and the like that may be mentioned throughout the entire description may be expressed by one or an arbitrary combination of voltage, current, electromagnetic waves, magnetic fields, magnetic particles, optical fields, and photons.

Note that, the terms described in the present disclosure and the terms necessary to understand the present disclosure may be replaced with terms with the same or similar meaning. For example, at least one of the channel and the symbol may be a signal (signaling). The signal may be a message. The Component Carrier (CC) may be called a carrier frequency, a cell, a frequency carrier, or the like.

### System and Network

The terms “system” and “network” used in the present disclosure can be interchangeably used.

### Names of Parameters and Channels

The information, the parameters, and the like described in the present disclosure may be expressed using absolute values, using values relative to predetermined values, or using other corresponding information. For example, radio resources may be indicated by indices.

The names used for the parameters are not limitative in any respect. Further, the numerical formulas and the like using the parameters may be different from the ones explicitly disclosed in the present disclosure. Various channels (for example, PUCCH and PDCCH) and information elements can be identified by any suitable names, and various names assigned to these various channels and information elements are not limitative in any respect.

### Base Station

The terms “Base Station (BS)”, “radio base station”, “fixed station”, “NodeB”, “eNodeB (eNB)”, “gNodeB (gNB)”, “access point”, “transmission point”, “reception point, “transmission/reception point”, “cell”, “sector”, “cell group”, “carrier”, “component carrier”, and the like may be used interchangeably in the present disclosure. The base station may be called a macro cell, a small cell, a femtocell, or a pico cell.

The base station can accommodate one cell or a plurality of (for example, three) cells. When the base station accommodates a plurality of cells, the entire coverage area of the base station can be divided into a plurality of smaller areas, and each of the smaller areas can provide a communication service based on a base station subsystem (for example, small base station for indoor (RRH: Remote Radio Head)). The term “cell” or “sector” denotes part or all of the coverage area of at least one of the base station and the base station subsystem that perform the communication service in the coverage.

### Mobile Station

The terms “Mobile Station (MS)”, “user terminal”, “User Equipment (UE)”, and “terminal” may be used interchangeably in the present disclosure.

The mobile station may be called, by those skilled in the art, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or by some other appropriate terms.

### Base Station/Mobile Station

At least one of the base station and the mobile station may be called a transmission apparatus, a reception apparatus, a communication apparatus, or the like. Note that, at least one of the base station and the mobile station may be a device mounted in a mobile entity, the mobile entity itself, or the like. The mobile entity refers to a movable object, and has any moving speed. Naturally, the mobile entity in a state of being stopped is also encompassed. Examples of the mobile entity include, but are not limited to, vehicles, transport vehicles, automobiles, motorcycles, bicycles, connected cars, excavators, bulldozers, wheel loaders, dump trucks, forklifts, trains, buses, rear cars, manpower vehicles, ships and other watercrafts, airplanes, rockets, satellites, drones (registered trademark), multicopters, quadcopters, balloons, and goods loaded thereon. Further, the mobile entity may be a mobile entity that autonomously travels based on an operation command. The mobile entity may be a means of transport (for example, a car, an airplane, or the like), an unmanned mobile entity (for example, a drone, an autonomous driving vehicle, or the like), or a robot (a manned or unmanned robot). Note that, at least one of the base station and the mobile station also includes an apparatus that does not necessarily move during communication operation. For example, at least one of the base station and the mobile station may be Internet-of-Things (IoT) equipment such as a sensor.

The base station in the present disclosure may also be replaced with the terminal. For example, the embodiment of the present disclosure may find application in a configuration that results from replacing communication between the base station and the terminal with communication between a plurality of terminals (such communication may, for example, be referred to as Device-To-Device (D2D), Vehicle-To-Everything (V2X), or the like). In this case, terminal 200 may be configured to have the functions that base station 100 described above has. The wordings “uplink” and “downlink” may be replaced with a corresponding wording for inter-terminal communication (for example, “side”). For example, an uplink channel, a downlink channel, and the like may be replaced with a side channel.

Similarly, the terminal in the present disclosure may be replaced with the base station. In this case, base station 100 may be configured to have the functions that terminal 200 described above has.

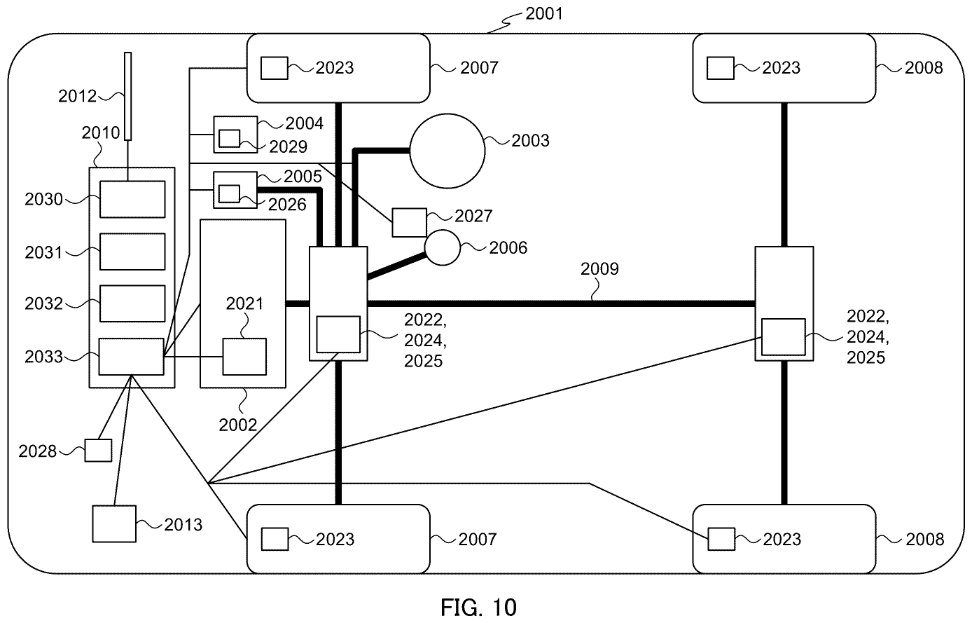

FIG. 10 illustrates a configuration example of vehicle 2001. As illustrated in FIG. 10, vehicle 2001 includes drive section 2002, steering section 2003, accelerator pedal 2004, brake pedal 2005, shift lever 2006, front wheels 2007, rear wheels 2008, axle 2009, electronic control section 2010, various sensors 2021 to 2029, information service section 2012, and communication module 2013. The aspects and embodiment described in the present disclosure may be applied to a communication apparatus mounted in vehicle 2001, and, for example, may be applied to communication module 2013.

Drive section 2002 is formed of, for example, an engine, a motor, or a hybrid of an engine and a motor. Steering section 2003 includes at least a steering wheel (also referred to as a driving wheel or a hand wheel) and is configured to steer at least one of the front wheels and the rear wheels based on an operation of the steering wheel operated by the user.

Electronic control section 2010 includes microprocessor 2031, memory (ROM and/or RAM) 2032, and communication port (IO port) 2033. Signals from various sensors 2021 to 2029 provided in the vehicle are inputted to electronic control section 2010. Electronic control section 2010 may be referred to as an electronic control unit (ECU).

The signals from various sensors 2021 to 2029 include a current signal from current sensor 2021 for sensing the current of the motor, a rotational speed signal of the front and/or rear wheels acquired by rotational speed sensors 2022, a pneumatic signal of the front and/or rear wheels acquired by pneumatic sensors 2023, a vehicle speed signal acquired by vehicle speed sensors 2024, an acceleration signal acquired by acceleration sensors 2025, an accelerator pedal depression amount signal acquired by accelerator pedal sensor 2029, a brake pedal depression amount signal acquired by brake pedal sensor 2026, an shift lever operation signal acquired by shift lever sensor 2027, a detection signal for detecting an obstacle, a vehicle, a pedestrian, or the like acquired by object detection sensor 2028, and the like.

Information service section 2012 is formed of various devices such as a car navigation system, an audio system, a speaker, a television, and a radio for providing various pieces of information such as driving information, traffic information, entertainment information, and the like, and of one or more ECUs for controlling these devices. Information service section 2012 provides various pieces of multimedia information and multimedia services to an occupant of vehicle 2001 by utilizing information acquired from an external apparatus via communication module 2013 or the like.

Driver assistance system section 2030 is formed of: various devices such as millimeter-wave radar, Light Detection and Ranging (LiDAR), a camera, a positioning locator (for example, GNSS or the like), a map information (for example, high definition (HD) map, autonomous driving vehicle (AV) map or the like), a gyrosystem (for example, an Inertial Measurement Unit (IMU), an Inertial Navigation System (INS) or the like), an Artificial Intelligence (AI) chip, and an AI processor for providing functions for preventing accidents or reducing the driving load of the driver; and of one or more ECUs for controlling these devices. Further, driver assistance system section 2030 transmits and receives various pieces of information via communication module 2013, and realizes a driving support function or an autonomous driving function.

Communication module 2013 can communicate with microprocessor 2031 and the components of vehicle 2001 via a communication port. For example, communication module 2013 transmits and receives data to and from drive section 2002, steering section 2003, accelerator pedal 2004, brake pedal 2005, shift lever 2006, front wheels 2007, rear wheels 2008, axle 2009, and microprocessor 2031 and memory (ROM and/or RAM) 2032 in electronic control section 2010, and sensors 2021 to 2029, which are provided in vehicle 2001, via the communication port 2033.

Communication module 2013 is a communication device that can be controlled by microprocessor 2031 of electronic control section 2010 and can communicate with an external apparatus. For example, communication module 2013 transmits and receives various pieces of information to and from the external apparatus via radio communication. Communication module 2013 may be either inside or outside electronic control section 2010. The external apparatus may be, for example, a base station, a mobile station, or the like.

Communication module 2013 transmits, to the external apparatus via radio communication, a current signal inputted from the current sensor to electronic control section 2010. In addition, communication module 2013 transmits, to the external apparatus via radio communication, the rotational speed signal of the front and/or rear wheels acquired by rotation speed sensors 2022, the pneumatic signal of the front and/or rear wheels acquired by pneumatic sensors 2023, the vehicle speed signal acquired by vehicle speed sensors 2024, the acceleration signal acquired by acceleration sensors 2025, the accelerator pedal depression amount signal acquired by accelerator pedal sensor 2029, the brake pedal depression amount signal acquired by brake pedal sensor 2026, the shift lever operation signal acquired by shift lever sensor 2027, the detection signal for detecting an obstacle, a vehicle, a pedestrian, and the like acquired by object detection sensor 2028, and the like, which are signals inputted to electronic control section 2010.

Communication module 2013 receives various pieces of information (traffic information, signal information, inter-vehicle information or the like) transmitted from the external apparatus, and displays the information on information service section 2012 provided in the vehicle. Further, communication module 2013 stores the various pieces of information received from the external apparatus in memory 2032 accessible by microprocessor 2031. Based on the information stored in memory 2032, microprocessor 2031 may control drive section 2002, steering section 2003, accelerator pedal 2004, brake pedal 2005, shift lever 2006, front wheels 2007, rear wheels 2008, axle 2009, sensors 2021 to 2029, and the like, which are provided in vehicle 2001.

### Meaning and Interpretation of Terms

The term “determining” used in the present disclosure may encompass a wide variety of actions. For example, “determining” may be regarded as judging, calculating, computing, processing, deriving, investigating, looking up (or searching or inquiring) (for example, looking up in a table, a database or another data structure), and ascertaining, and the like. Further, “determining” may be regarded as receiving (for example, receiving information), transmitting (for example, transmitting information), inputting, outputting, and accessing (for example, accessing data in memory), and the like. Further, “determining” may be regarded as resolving, selecting, choosing, establishing, comparing, and the like. That is, “determining” may be regarded as “determining” a certain type of action. Further, “determining” may be replaced with “assuming”, “expecting”, “considering”, and the like.

The terms “connected” and “coupled” as well as any modifications of the terms mean any direct or indirect connection and coupling between two or more elements, and the terms can include cases in which one or more intermediate elements exist between two “connected” or “coupled” elements. The coupling or the connection between elements may be physical or logical coupling or connection or may be a combination of physical and logical coupling or connection. For example, “connected” may be replaced with “accessed”. When the terms are used in the present disclosure, two elements can be considered to be “connected” or “coupled” to each other using at least one of one or more electrical wires, cables, and printed electrical connections or using electromagnetic energy with a wavelength of a radio frequency domain, a microwave domain, an optical (both visible and invisible) domain, or the like that are non-limiting and non-inclusive examples.

### Reference Signal

The reference signal can also be abbreviated as an RS and may also be called as a pilot depending on the applied standard.

### Meaning of “Based On”

The description “based on” used in the present disclosure does not mean “based only on”, unless otherwise specified. In other words, the description “based on” means both of “based only on” and “based at least on”.

### “First” and “Second”

Any reference to elements by using the terms “first”, “second”, and the like that are used in the present disclosure does not generally limit the quantities of or the order of these elements. The terms can be used as a convenient method of distinguishing between two or more elements in the present disclosure. Therefore, reference to first and second elements does not mean that only two elements can be employed, or that the first element has to precede the second element somehow.

### “Means”

The “means” in the configuration of each apparatus described above may be replaced with “section”, “circuit”, “device”, or the like.

### Open-Ended Format

In a case where terms “include”, “including”, and their modifications are used in the present disclosure, these terms are intended to be inclusive like the term “comprising”. Further, the term “or” used in the present disclosure is not intended to be an exclusive or.

### Time Units Such as TTI, Frequency Units Such as RB, and Radio Frame Configuration

The radio frame may be formed of one frame or a plurality of frames in the time domain. The one frame or each of the plurality of frames may be called a sub frame in the time domain. The sub frame may be further formed of one slot or a plurality of slots in the time domain. The sub frame may have a fixed time length (for example, 1 ms) independent of numerology.

The numerology may be a communication parameter that is applied to at least one of transmission and reception of a certain signal or channel. The numerology, for example, indicates at least one of SubCarrier Spacing (SCS), a bandwidth, a symbol length, a cyclic prefix length, Transmission Time Interval (TTI), the number of symbols per TTI, a radio frame configuration, specific filtering processing that is performed by a transmission and reception apparatus in the frequency domain, specific windowing processing that is performed by the transmission and reception apparatus in the time domain, and the like.

The slot may be formed of one symbol or a plurality of symbols (for example, Orthogonal Frequency Division Multiplexing (OFDM)) symbol, Single Carrier-Frequency Division Multiple Access (SC-FDMA) symbol, or the like) in the time domain. The slot may also be a time unit based on the numerology.

The slot may include a plurality of mini-slots. Each of the mini-slots may be formed of one or more symbols in the time domain. Further, the mini-slot may be referred to as a subslot. The mini-slot may be formed of a smaller number of symbols than the slot. A PDSCH (or a PUSCH) that is transmitted in the time unit that is greater than the mini-slot may be referred to as a PDSCH (or a PUSCH) mapping type A. The PDSCH (or the PUSCH) that is transmitted using the mini-slot may be referred to as a PDSCH (or PUSCH) mapping type B.

The radio frame, the sub frame, the slot, the mini slot, and the symbol indicate time units in transmitting signals. The radio frame, the sub frame, the slot, the mini slot, and the symbol may be called by other corresponding names.

For example, one sub frame, a plurality of continuous sub frames, one slot, or one mini-slot may be called a Transmission Time Interval (TTI). That is, at least one of the sub frame and the TTI may be a sub frame (1 ms) in the existing LTE, a duration (for example, 1 to 13 symbols) that is shorter than 1 ms, or a duration that is longer than 1 ms. Note that, a unit that represents the TTI may be referred to as a slot, a mini-slot, or the like instead of a sub frame.

Here, the TTI, for example, refers to a minimum time unit for scheduling in radio communication. For example, in an LTE system, the base station performs scheduling for allocating a radio resource (frequency bandwidth, transmit power, and the like that are used in each user terminal) on a TTI-by-TTI basis to each user terminal. Note that, the definition of TTI is not limited thereto.

The TTI may be a time unit for transmitting a channel-coded data packet (a transport block), a code block, or a codeword, or may be a unit for processing such as scheduling and link adaptation. Note that, when the TTI is assigned, a time section (for example, the number of symbols) to which the transport block, the code block, the codeword, or the like is actually mapped may be shorter than the TTI.

Note that, in a case where one slot or one mini-slot is referred to as the TTI, one or more TTIs (that is, one or more slots, or one or more mini-slots) may be a minimum time unit for the scheduling. Further, the number of slots (the number of mini-slots) that forms the minimum time unit for the scheduling may be controlled.

A TTI that has a time length of 1 ms may be referred to as a usual TTI (a TTI in LTE Rel. 8 to LTE Rel. 12), a normal TTI, a long TTI, a usual sub frame, a normal sub frame, a long sub frame, a slot, or the like. A TTI that is shorter than the usual TTI may be referred to as a shortened TTI, a short TTI, a partial TTI (or a fractional TTI), a shortened sub frame, a short sub frame, a mini-slot, a subslot, a slot, or the like.

Note that, the long TTI (for example, usual TTI, sub frame, or the like) may be replaced with the TTI that has a time length which exceeds 1 ms, and the short TTI (for example, shortened TTI or the like) may be replaced with a TTI that has a TTI length which is less than a TTI length of the long TTI and is equal to or longer than 1 ms.

A resource block (RB) is a resource allocation unit in the time domain and the frequency domain, and may include one or more contiguous subcarriers in the frequency domain. The number of subcarriers that are included in the RB may be identical regardless of the numerology, and may be 12, for example. The number of subcarriers that are included in the RB may be determined based on the numerology.

In addition, the RB may include one symbol or a plurality of symbols in the time domain, and may have a length of one slot, one mini slot, one sub frame, or one TTI. One TTI and one sub frame may be formed of one resource block or a plurality of resource blocks.

Note that, one or more RBs may be referred to as a Physical Resource Block (PRB), a Sub-Carrier Group (SCG), a Resource Element Group (REG), a PRB pair, an RB pair, or the like.

In addition, the resource block may be formed of one or more Resource Elements (REs). For example, one RE may be a radio resource region that is one subcarrier and one symbol.

A bandwidth part (BWP) (which may be referred to as a partial bandwidth or the like) may represent a subset of contiguous common resource blocks (RB) for certain numerology in a certain carrier. Here, the common RBs may be identified by RB indices that use a common reference point of the carrier as a reference. The PRB may be defined by a certain BWP and may be numbered within the BWP.

The BWP may include a UL BWP and a DL BWP. A UE may be configured with one or more BWPs within one carrier.

At least one of the configured BWPs may be active, and the UE does not have to assume transmission/reception of a predetermined signal or channel outside the active BWP. Note that, “cell”, “carrier”, and the like in the present disclosure may be replaced with “BWP”.

Structures of the radio frame, the sub frame, the slot, the mini-slot, the symbol, and the like are described merely as examples. For example, the configuration such as the number of sub frames that are included in the radio frame, the number of slots per sub frame or radio frame, the number of mini-slots that are included within the slot, the numbers of symbols and RBs that are included in the slot or the mini-slot, the number of subcarriers that are included in the RB, the number of symbols within the TTI, the symbol length, the Cyclic Prefix (CP) length, and the like can be changed in various ways.

### Maximum Transmit Power

The “maximum transmit power” described in the present disclosure may mean a maximum value of the transmit power, the nominal UE maximum transmit power, or the rated UE maximum transmit power.

### Article

In a case where articles, such as “a”, “an”, and “the” in English, for example, are added in the present disclosure by translation, nouns following these articles may have the same meaning as used in the plural.

### “Different”

In the present disclosure, the expression “A and B are different” may mean that “A and B are different from each other”. Note that, the expression may also mean that “A and B are different from C”. The expressions “separated” and “coupled” may also be interpreted in the same manner as the expression “A and B are different”.

### Industrial Applicability

An aspect of the present disclosure is useful for radio communication systems.

### REFERENCE SIGNS LIST

10 Radio communication system
20 Radio access network
100 Base station
101 Transmission section
102 Reception section
103 Control section
200 Terminal
201 Reception section
202 Transmission section
203 Control section

1-5. (canceled)

6. A terminal, comprising:
a receiver that receives a downlink control signal in a specific format for notifying a Physical Resource Block (PRB) and an Orthogonal Frequency Division Multiplexing (OFDM) symbol where the terminal cancels an uplink transmission from the terminal; and
a processor that cancels, based on a indication in the downlink control signal, an uplink shared channel transmission in which uplink control information of different priorities has been multiplexed.

7. The terminal according to claim 6, wherein the specific format is Downlink Control Information (DCI) format 2_4.

8. 1 A communication method, comprising:
receiving, by a terminal, a downlink control signal in a specific format for notifying a Physical Resource Block (PRB) and an Orthogonal Frequency Division Multiplexing (OFDM) symbol where the terminal cancels an uplink transmission from the terminal; and
canceling, by the terminal, based on a indication in the downlink control signal, an uplink shared channel transmission in which uplink control information of different priorities has been multiplexed.
